(19) United States
(12) Patent Application Publication
(10) Pub. No.: US 2025/0370981 A1
(43) Pub. Date: Dec. 4, 2025

(54) METHODS AND SYSTEMS FOR UPDATING KNOWLEDGE BASE DOCUMENTS

(71) Applicant: QlikTech International AB, Lund (SE)

(72) Inventors: Dror Harari, Kfar Saba (IL); Ofer Haramati, King of Prussia, PA (US); Amir Egozi, Kfar Saba (IL); Vladimir Vainer, Tel Aviv (IL)

(21) Appl. No.: 19/226,544

(22) Filed: Jun. 3, 2025

Related U.S. Application Data
(60) Provisional application No. 63/655,239, filed on Jun. 3, 2024.

(51) Int. Cl. G06F 16/23; G06F 16/22

(52) U.S. Cl. CPC G06F 16/23; G06F 16/2228

(57) ABSTRACT

Described herein are methods and systems for updating knowledge bases for Retrieval-Augmented Generation (RAG) applications. The methods employ Change Data Capture (CDC) to efficiently detect modifications in source data. These CDC techniques may enable targeted updates to semantic indexing tables by traversing data models from leaf tables to root entities, ensuring that only affected embeddings are regenerated rather than reprocessing entire document collections.

### CROSS-REFERENCE TO RELATED PATENT APPLICATION

This application claims priority to U.S. Prov. App. No. 63/655,239, filed on Jun. 3, 2024, the entirety of which is incorporated by reference herein.

### BACKGROUND

Retrieval-Augmented Generation (RAG) is a synergistic technology that merges Large Language Models (LLMs) with external knowledge bases to enhance the accuracy and relevance of generated responses. Knowledge bases, comprising structured and unstructured data, serve as external information sources to LLMs, facilitating easy retrieval and integration of information. In RAG systems, LLMs interpret queries and draft responses, while knowledge bases contribute supplementary data beyond the LLMs' training, leading to more precise and informative answers. A core component of RAG systems is the development and upkeep of a document collection. Updating this collection requires the identification of source data changes and the modification of impacted documents, typically on a set schedule or in reaction to data alterations. This process, however, may be challenged by high costs and complexity associated with document regeneration and update detection. These and other considerations are discussed herein.

### SUMMARY

It is to be understood that both the following general description and the following detailed description are exemplary and explanatory only and are not restrictive.

Described herein are methods and systems for updating knowledge bases for Retrieval-Augmented Generation (RAG) applications. A data warehouse may store existing data that may be transformed into language model-consumable data through a data conversion process. The methods employ Change Data Capture (CDC) techniques to efficiently detect modifications in source data. These CDC methods enable targeted updates to semantic indexing tables by traversing data models from leaf tables to root entities, ensuring that affected embeddings are regenerated in the vector database rather than reprocessing entire document collections. This summary is not intended to identify critical or essential features of the disclosure, but merely to summarize certain features and variations thereof. Other details and features will be described in the sections that follow.

### BRIEF DESCRIPTION OF THE DRAWINGS

The accompanying drawings, which are incorporated in and constitute a part of this specification, together with the description, serve to explain the principles of the present methods and systems:

FIG. 1 shows an example system.

FIG. 2 shows an example system.

FIG. 3A shows an example system.

FIG. 3B shows an example process.

FIG. 4A shows an example data model diagram.

FIG. 4B shows an example class diagram.

FIG. 4C shows an example entity document.

FIGS. 5A-5B show example data model diagrams.

FIGS. 6A and 6B show an example data model diagram.

FIGS. 7A-7C show components of an example system.

FIG. 7D shows an example table.

FIG. 7E shows an example query.

FIG. 8 shows a block diagram of an example computing environment.

FIG. 9 illustrates a flowchart of an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. When values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude other components, integers, or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memristors, Non-Volatile Random Access Memory (NVRAM), flash memory, or a combination thereof.

Throughout this application, reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general-purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Accordingly, blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

The present disclosure relates to methods and systems for updating documents, such as documents within knowledge bases in Retrieval-Augmented Generation (RAG) applications, assistant applications, etc. In some aspects, the methods and systems may transform existing data into a format that is consumable by Large Language Models (LLMs). The existing data may include unstructured, file-based sources, such as presentations, mail archives, text documents, PDFs, transcripts, and the like. The existing data may also include structured data from a data warehouse. The transformation process may involve splitting the existing data into manageable chunks and converting each chunk into an embedding using an LLM. The embeddings may then be stored in a vector database and semantically indexed, creating a knowledge base that preserves the context and relationships within the data.

In addition to transforming existing data into LLM-consumable data, the methods and systems may also efficiently identify and process updates to the existing data. The identification of updates may be facilitated by change data capture (CDC) techniques, which detect additions, changes, or updates to data records within the existing data. The detected updates may then be processed to update the corresponding embeddings in the vector database. This update process may involve traversing a data model associated with the existing data, identifying the portions of the existing data that have been changed, added, or updated, and regenerating the embeddings for these portions. The updated embeddings may then be stored in the vector database, ensuring that the knowledge base remains current and accurate.

The methods and systems may provide several advantages. For example, they may allow for the amount of work to update a document collection to be proportional to the volume of changes rather than the overall size of the document collection. This may conserve computational resources and reduce processing time. Additionally, the methods and systems may enable the creation and maintenance of the document collection to be managed by a single no-code engine, simplifying the management process and reducing the dependency on specialized development resources. Furthermore, the methods and systems may provide consistent and predictable operational costs when using external LLM services for generating embeddings, enabling better financial planning and resource allocation.

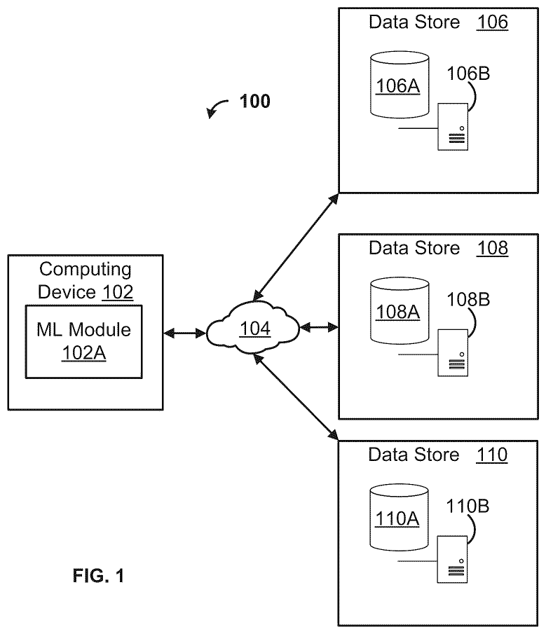

Turning now to FIG. 1, a block diagram of an example system 100 is shown. The system 100 may include a computing device 102 and a plurality of data stores 106, 108, 110 each in communication with the computing device 102 via a network 104. The computing device 102 may comprise a Machine Learning (ML) module 102A. The ML module 102A may comprise and/or facilitate access to a plurality of ML models, such as at least one neural network, at least one Large Language Model (LLM), at least one segmentation model, at least one ensemble model, a combination thereof, and/or the like. Though the ML module 102A is shown in FIG. 1 as being resident at the computing device 102, it is to be understood that the ML module 102A may be resident at one or more computing devices that may be local or remote to the computing device 102. Each of the plurality of data stores 106, 108, 110 may comprise one or more data storage mechanisms, such as a relational database, an in-memory data store, a log, or any other data storage repository configured for a retrieval interface. For ease of explanation, the plurality of data stores 106, 108, 110 may be referred to herein as a “plurality of databases.” It is to be understood that any “database” referred to herein may comprise any type of suitable data storage mechanism.

The network 104 may facilitate communication between the plurality of data stores 106, 108, 110 and the computing device 102. The network 104 may be an optical fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent from any of the plurality of data stores 106, 108, 110 to the computing device 102 via a variety of transmission paths, including wireless paths (e.g., satellite paths, Wi-Fi paths, cellular paths, etc.) and terrestrial paths (e.g., wired paths, a direct feed source via a direct line, etc.). Additionally, data may be sent from the computing device 102 to any of the plurality of data stores 106, 108, 110 via a variety of transmission paths, including wireless paths and terrestrial paths.

The plurality of data stores 106, 108, 110 may be part of a large data storage network consisting of numerous, disparate data stores. For example, the plurality of data stores 106, 108, 110 may be used by an enterprise to store customer data. Each of the plurality of data stores 106, 108, 110 may include a database 106A, 108A, 110A, and a server 106B, 108B, 110B. Each server 106B, 108B, 110B may enable the computing device 102 to communicate with, and retrieve data from, each of the databases 106A, 108A, 110A. Each of the databases 106A, 108A, 110A may be a different type of database. For example, the database 106A may be an Oracle™ database, while the database 108A may be a MySQL™ database.

In some aspects, the ML module 102A may access and process data from the databases 106A, 108A, 110A. For example, and as further described herein, the ML module 102A may retrieve data from one or more of the databases 106A, 108A, 110A, process the data to generate embeddings, and store the embeddings in a suitable storage medium. The embeddings may be used to represent the data in a format that is suitable for processing by the ML module 102A or other components of the system 100. In some cases, the ML module 102A may process the data in real-time or near real-time, allowing the system 100 to provide up-to-date responses to user queries or other requests. In other cases, the ML module 102A may process the data in batches, allowing the system 100 to efficiently process large amounts of data. In some aspects, as further described herein, the system 100 may update the embeddings based on changes or updates to the data in the databases 106A, 108A, 110A. For example, when new data is added to a database, or when existing data in a database is updated or changed, the ML module 102A may generate new embeddings or update existing embeddings to reflect the changes or updates to the data. This may allow the system 100 to maintain an up-to-date representation of the data in the databases 106A, 108A, 110A.

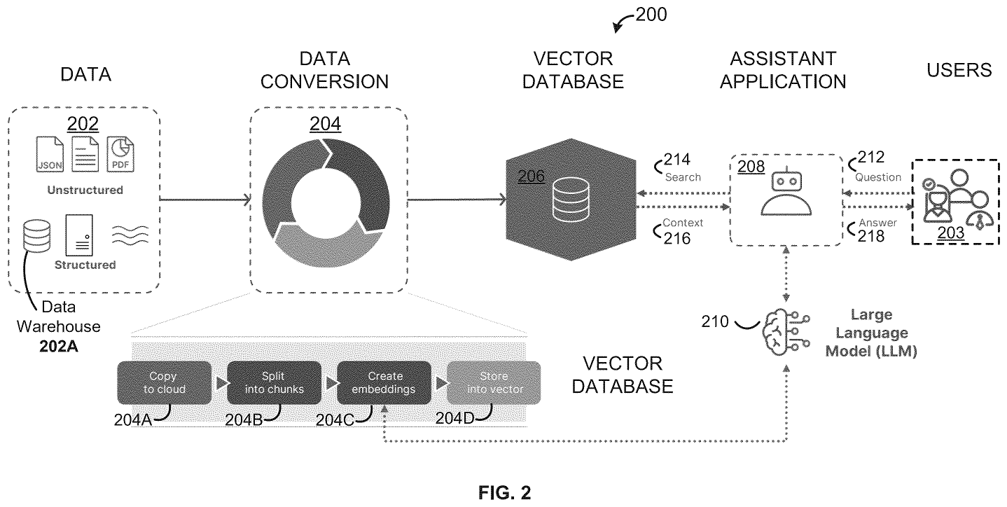

FIG. 2 shows an example system 200. The system 200 may comprise one or more components of the system 100, as further described herein. That is, the capabilities of the system 200 as described herein also apply to the system 100, as the two systems may share—or may each comprise—each described component, resource, device, etc., that performs each of the actions described herein (and potentially not shown).

In some aspects, the system 200 may be utilized to transform data 202 into a format that may be consumed by Large Language Models (LLMs). For example, the data 202 may comprise unstructured, file-based sources, such as presentations, mail archives, text documents, PDFs, transcripts, etc. As shown in FIG. 2, the data 202 may comprise a data warehouse 202A. In some examples, all of the data 202 may be stored in the data warehouse 202A, while in other examples the data warehouse 202A may only store a portion(s) of the data 202. The text of the data 202 may be split into manageable chunks in a data conversion process 204. At step 204A, the data 202 may be copied to a cloud-based environment and split into chunks (e.g., portions of text data) at step 204B. The size of these chunks may vary depending on various factors. For instance, the complexity of the data or the computational resources available may influence the size of the chunks. In some cases, larger chunks may be used if the data is relatively simple and ample computational resources are available. In other cases, smaller chunks may be used if the data is complex or computational resources are limited.

Once the data is split into chunks, each chunk may be converted into an embedding at step 204C. This conversion may be performed by an LLM or another type of machine learning model. Different types of LLMs may be used depending on the specific requirements of the task. In some cases, other machine learning models that are not LLMs may be used to convert the chunks into embeddings. For example, transformer-based models, recurrent neural network models, and/or convolutional neural network models may be used. Transformer-based models, such as BERT (Bidirectional Encoder Representations from Transformers), GPT (Generative Pre-trained Transformer), and T5 (Text-to-Text Transfer Transformer), are particularly well-suited for natural language processing tasks. These models use self-attention mechanisms to process input data, allowing them to capture long-range dependencies and contextual information effectively. Recurrent Neural Network (RNN) models, including Long Short-Term Memory (LSTM) and Gated Recurrent Unit (GRU) networks, are designed to handle sequential data. They maintain an internal state that can capture information from previous inputs, making them useful for tasks involving time-series data or text sequences. Convolutional Neural Network (CNN) models, traditionally used for image processing, have also been adapted for text analysis. They can efficiently capture local patterns and hierarchical features in data, which can be beneficial for certain types of text classification or feature extraction tasks.

In addition to these LLMs, other machine learning models may be employed for creating embeddings. That is, in some cases, one or more other machine learning models that are not LLMs may be used to convert the chunks into embeddings. For case of explanation, however, these one or more other machine learning LLMs that may be used will be referred to as one or more LLMs. For instance, traditional word embedding models like Word2Vec, GloVe (Global Vectors for Word Representation), or FastText can be used to generate vector representations of words or phrases. Dimensionality reduction techniques such as Principal Component Analysis (PCA) or t-SNE (t-Distributed Stochastic Neighbor Embedding) can also be applied to create lower-dimensional embeddings of high-dimensional data. The choice of model depends on factors such as the nature of the data (e.g., text, numerical, categorical), the specific requirements of the task (e.g., accuracy, processing speed, interpretability), and the available computational resources. In some cases, a combination of different models may be used to combine their respective strengths and create more robust or versatile embeddings.

In some examples, at step 204C, each chunk may be converted into an embedding via an LLM, such as the LLM 210 in FIG. 2. Each embedding may comprise a numerical representation of the corresponding chunk of the data 202 that may be consumed/used by an LLM(s) (e.g., by the LLM 210). The embeddings may then be stored in a vector database 206 at step 204D. The vector database 206 may then semantically index the embeddings, which involves organizing the numerical representations of the data chunks in a manner that reflects the semantic meaning of the content within each chunk. This semantic indexing may facilitate more efficient and accurate retrieval of information in response to queries. In some aspects, the semantic indexing may use algorithms that understand the context and relationships between different words and phrases within the embeddings, allowing for a more nuanced search capability. The indexing process may also involve the creation of an index map that correlates the embeddings with their respective data chunks, enabling quick access to the original data when a relevant embedding is identified. Additionally, the vector database 206 may employ techniques such as dimensionality reduction to optimize the storage and retrieval of embeddings without losing the semantic relationships within the data.

After embeddings are generated and semantically indexed in the vector database 206, an assistant application 208, such as a natural language (“NL”) assistant and/or a chatbot, may provide NL answers to queries related to the data 202. For example, the assistant application 208 may interact with the LLM 210 to process natural language queries from one or more users. The one or more users 203 may interact with the assistant application 208 via a client device, such as the computing device 102, a mobile device, or a web browser. The assistant application 208 may be designed to provide responses in various formats. In some cases, the assistant application 208 may provide text-based responses. In other cases, the assistant application 208 may provide visual or auditory responses. For example, the assistant application 208 may generate a graphical representation of the response, or it may generate an audio file that verbally communicates the response.

As shown in FIG. 2, the one or more users 203 may send a question 212 (e.g., a NL query) to the assistant application 208. The assistant application 208 may perform a search 212 against the vector database 206 in order to receive context 216 that may be based on the embeddings of the data 202, and the context 216 may be used by the assistant application 208 to provide an answer 218 (e.g., a NL answer/output). In this way, the “knowledge” used by the system 200 to provide answers 218 to searches 212 may be augmented using the data 202, which forms the basis for the context 216 provided to the assistant application 208.

The assistant application 208 may be designed to interact with users in a conversational manner. This may allow for more complex and dynamic interactions between the users 203 and the assistant application 208. For example, the assistant application 208 may be capable of maintaining a conversation with a user over multiple exchanges, keeping track of the context of the conversation and providing responses that are relevant to the ongoing conversation. In some aspects, the assistant application 208 may be integrated with other systems or applications to provide additional functionality. For example, the assistant application 208 may be integrated with a customer relationship management system, a content management system, a data analysis system, or any other type of system or application. This integration may allow the assistant application 208 to access additional data, leverage additional computational resources, or provide additional services to users.

In analytics systems (e.g., SaaS systems), the unstructured, file-based sources that may be used to generate a knowledge base(s), such as the vector database 206, may be contained within one or more “apps” (short for applications). From a technical standpoint, an app in an analytics system is a self-contained environment designed to facilitate data analysis and visualization. It serves as a comprehensive workspace where users can load, manipulate, and analyze data to create interactive reports and dashboards. Within an app, data connections are established to various sources such as databases, spreadsheets, and web services, allowing the importation of data. The app then structures this data into a data model, which includes tables and their relationships. A “data load script” for the app may define how data is imported and transformed within the app. Users may create “sheets” within the app to layout their analyses, populating them with interactive “visualizations” like charts, graphs, and tables that are driven by the underlying data. These visualizations may be standardized using “master items,” ensuring consistency and reusability across the app.

Additionally, users may create one or more “stories” associated with an app, which may be narratives combining visual elements and text to present insights comprehensively. “Bookmarks” associated with an app may allow users to save specific states of the app, capturing selections and filters for quick access to particular views. “Extensions” may enable the addition of custom visualizations and functionalities, enhancing the app's capabilities. An app may also incorporate “security rules” to define access permissions and data visibility, ensuring that users only see the data they are authorized to access.

To create a knowledge base from an app, such as for use in a Retrieval-Augmented Generation (RAG) system (e.g., the system 200), the system 200 may retrieve and structure a comprehensive set of data and metadata from the app. This data forms the foundation of the knowledge base, allowing the RAG system to generate accurate and contextually relevant responses to user queries. First, the system 200 gathers details about the data connections, including information about the data sources connected to the app (e.g., the data 202) and the necessary authentication credentials. Understanding the structure of the data model is crucial, so that the system 200 may extract information on the tables and fields imported into the app, the associations between tables, and relevant metadata for each field.

The data load script, which may define how data is imported and transformed, may be captured by the system 200, along with any applied data transformations. Information about the sheets and visualizations within the app, including their layout, types, underlying data, and metadata, may also collected by the system 200. This includes reusable dimensions, measures, and master visualizations defined in the app. The system 200 may also collect the content of any stories or presentations built within the app, including the visualizations and text used, as well as titles, descriptions, and relevant metadata. Additionally, details of saved bookmarks, including selections and filters, may be retrieved by the system 200. If the app uses any custom visualizations or extensions, the system 200 may gather information about these custom objects and their metadata.

To ensure the knowledge base remains current and accurate, the system 200 may periodically capture static data extracts or snapshots of the data used in the app. For example, a purpose-built API(s) may be used by the system 200 to programmatically extract the necessary data and metadata, ensuring that all relevant transformations and calculations are captured. The extracted data may then be organized into a structured format suitable for the knowledge base by the system 200. Including all relevant metadata provides context and enhances the usability of the knowledge base.

Indexing the knowledge base supports efficient retrieval of information, and techniques such as vectorization and semantic search, as performed by the vector database 206, enhance the retrieval capabilities for the system 200. Finally, setting up processes to periodically update the knowledge base with new data and changes from the app ensures the knowledge base remains current and accurate. By extracting and structuring this comprehensive set of information from an app, the system 200 may create—and maintain—a robust knowledge base for a RAG system, enabling it to provide accurate and contextually relevant answers to user queries.

To transform data from an app for use in the system 200, several steps are taken to ensure the data is appropriately structured and accessible for generating accurate and contextually relevant responses. First, data from the app is extracted by the system 200. This includes data from various sources connected to the app, as well as the data model, which comprises tables and their relationships. The data load script and any transformations applied within the app may be replicated by the system 200 to maintain consistency.

Once extracted, the data may be cleaned and pre-processed by the system 200. This may involve handling missing values, normalizing data formats, ensuring that all the transformations applied by the system 200 are consistent, a combination thereof, and/or the like. The goal of data cleaning and preprocessing is to create a structured dataset that the system 200 may easily index and query. Embeddings, which are dense vector representations of the data, may be created by the system 200, capturing the semantic meaning of textual content.

Text data associated with an app, such as descriptions, titles, and narratives, may be processed using Natural Language Processing (NLP) techniques by the large language model (LLM) 210. Models like BERT, GPT, or other transformer-based models may be used by the system 200 to convert this text data into embeddings as well (or in the alternative). For structured data, feature vectors representing all numerical attributes and/or categorical attributes within the structured data may be created by the system 200. Techniques like principal component analysis (PCA) and/or use of one or more autoencoders may be used by the system 200 to reduce dimensionality and create embeddings. The embeddings may then be indexed by the vector database 206. This indexing permits efficient similarity searches, enabling the system 200 to quickly retrieve relevant data points based on the query embeddings.

The embedded data forms a knowledge base, which includes indexed embeddings and associated metadata, ensuring that the context and relationships within the data are preserved by the system 200. Such knowledge bases may be stored in the vector database 206, which for purposes of explanation is shown in FIG. 2 as being a single vector database 206 but in some examples may comprise a plurality of vector databases 206. The system 200 may use knowledge bases stored in the vector database(s) 206 (and/or elsewhere) to generate responses as described herein. When a user's 203 question 212 is received, the system 200 may convert the question 212 into an embedding, retrieve relevant data from the vector database 206 using vector search, and/or generate responses using the assistant application 208. The retrieved data forms a context 216 that is then used to provide a contextually accurate and relevant answer(s) 218.

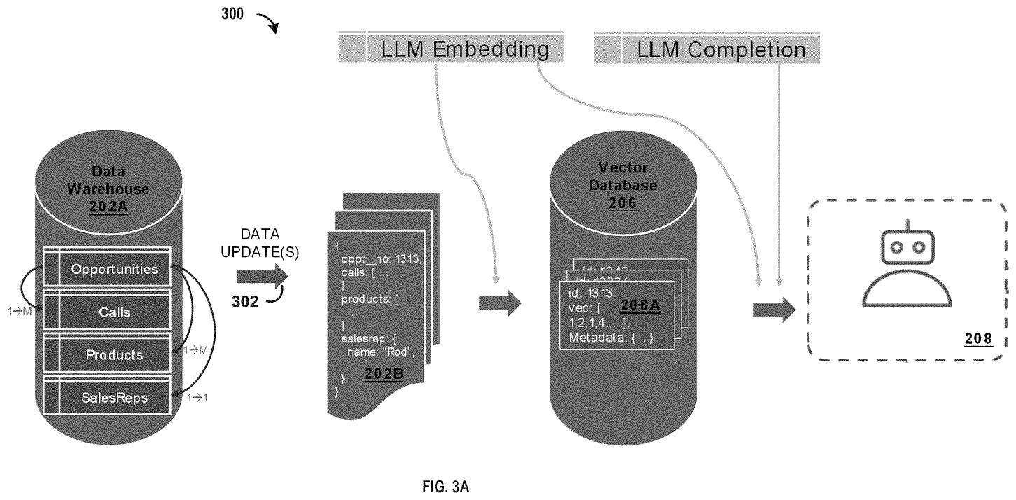

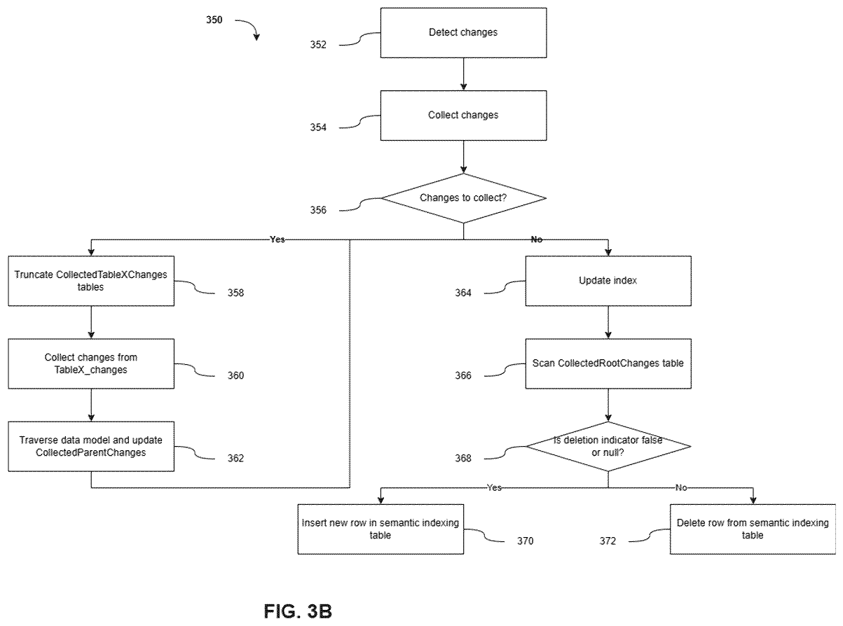

As mentioned above, the system 200 may transform existing data 202 into LLM-consumable data. The system 300 shown in FIG. 3A is configured to efficiently identify any changes and/or updates to existing data (e.g., existing data 202) used to generate the embeddings stored in the vector database 206. The system 300 may identify one or more portions of the existing data that have been changed, added, and/or updated (represented in FIG. 3A as “Data Update(s) 302). For example, the system 300 may use change data capture (CDC) techniques to determine that one or more data records within the existing data have been added, changed, or updated after the initial embeddings were stored in the vector database 206. In some examples, all of the existing data 202 may be stored in the data warehouse 202A, while in other examples the data warehouse 202 may only store a portion(s) of the existing data 202. For ease of explanation, the one or more portions of the existing data 202 that are identified as having been changed, added, and/or updated may be stored at, or accessible by, the data warehouse 202A. However, it is to be understood that the one or more portions of the existing data 202 that were changed, added, and/or updated may be stored elsewhere as well (or alternatively).

Due to the one or more portions of the existing data 202 that were changed, added, and/or updated, one or more embeddings stored in the vector database 206 may need to be updated as a result. For example, as shown in FIG. 3A, the data warehouse 202A shows an “Opportunities” data table with a one-to-many relationship to each of a “Calls” data table, a “Products” data table, and a “SalesReps” data table. The one-to-many relationships between those tables may mean that any addition, update and/or change to any data record within the Opportunities table may be associated with one or more additions, updates, and/or changes to one or more data records within each of those other tables. As an example, FIG. 3A shows an example addition, update and/or change 202B, which may correspond to the data update(s) 302 shown in FIG. 3A. The example addition, update and/or change 202B may comprise a newly-added, updated, and/or changed portion of the Opportunities table with references to the Products data table and the SalesRep data table as well (e.g., due to the one-to-many relationships).

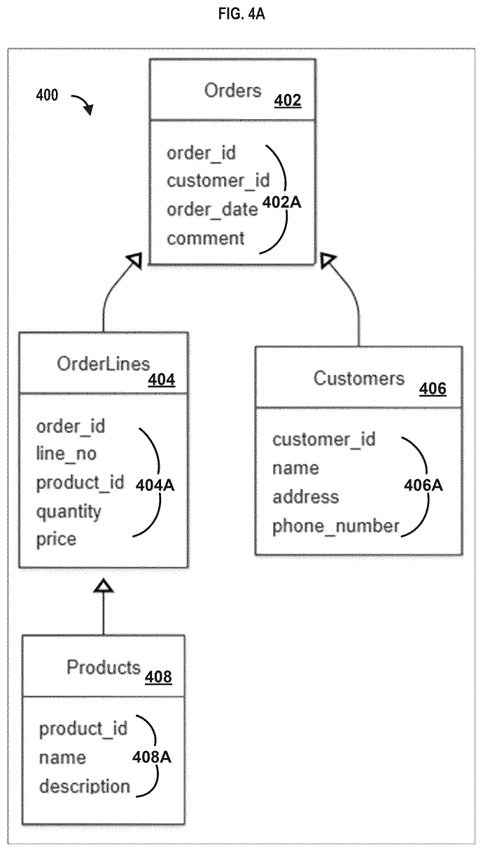

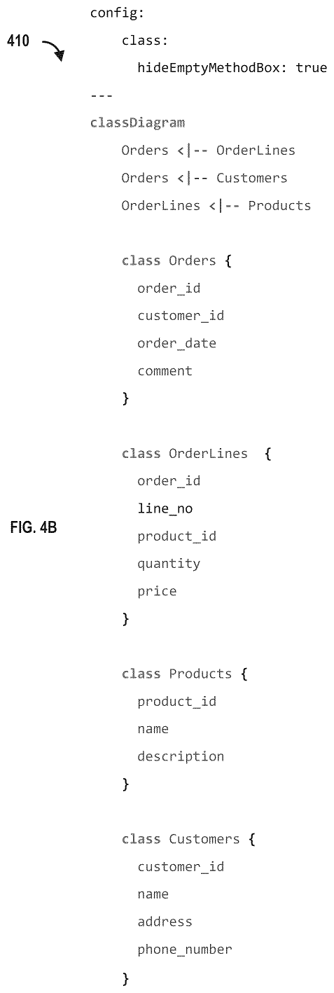

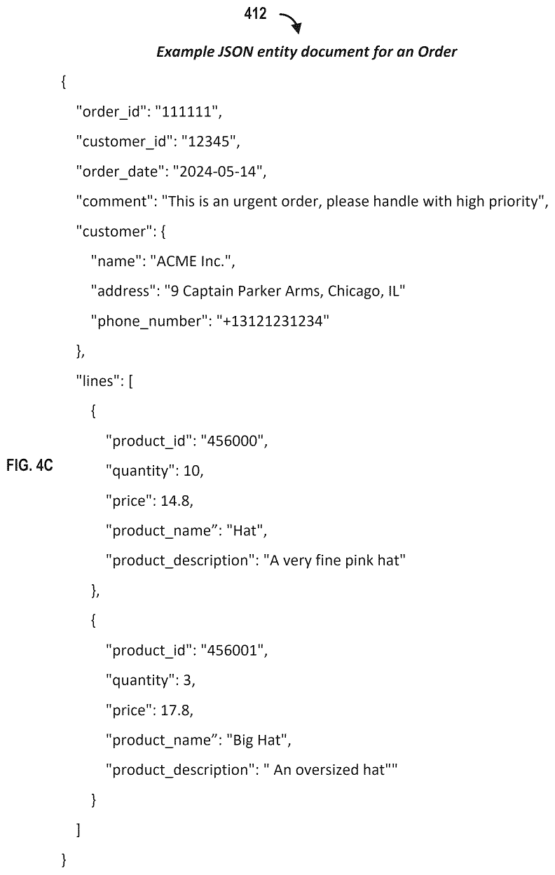

FIG. 3B illustrates a flowchart of a process 350 for detecting, collecting, and incorporating data changes in a data model. The process 350 is further described below with reference to FIGS. 4A-7C, each of which are described in detail first. FIG. 4A shows an example data model 400 comprising a set of tables 402, 406, and 408 with relationships, where one table is defined as the root entity (the “Orders” table in FIG. 4A is the root entity for this example). The system 300 may generate an “entity document” for each instance of the root entity (also referred to herein as the “entity of interest”). Each entity document is a textual document that represents the data available to a specific instance of the entity of interest. An entity document can be any kind of document, but for the purposes of explanation assume that for each instance of the root entity, a single entity document is generated. The entity document may be a JSON entity document. FIG. 4B, which illustrates a class diagram representation of the data model 400, may show the configuration and class relationships that could be used to implement the data model. The example code 410 in FIG. 4B may specify a class property “hideEmptyMethodBox” set to true, which could control how the classes are visually represented. The diagram may depict four interconnected classes: Orders, OrderLines, Products, and Customers, which could correspond to the tables shown in FIG. 4A. The relationships between these classes, which may be shown using arrow notations “<|--”, could indicate dependencies or associations that mirror the table relationships in the data model 400.

The “Example JSON entity document for an Order” 412 shown in FIG. 4C is an example JSON entity document generated for an order according to the data model 400. The details of the exact SQL statement(s) used for generating the example JSON entity document may vary. Therefore, the description herein assumes that a special entity document view was created in the database OrdersJsonDocs View (order_id, order_doc) that, when selected with the given order_id, returns the constructed JSON in the order_doc column. FIG. 4C, which provides a detailed view of the example JSON entity document 412, may illustrate how data from multiple related tables could be combined into a single hierarchical document. The JSON document, which may contain top-level order information including order_id “111111”, customer_id “12345”, order_date “2024 May 14”, and a comment field, could demonstrate the structure used for storing order data. The document may include a nested “customer” object with name, address, and phone_number fields, which could represent data from the Customers table 406. Additionally, the document might contain a “lines” array with multiple order line items, each of which may include product_id, quantity, price, product_name, and product_description, potentially representing data from the OrderLines table 404 and Products table 408. This structure could show how related order data might be organized hierarchically with the order details, customer information, and line items all contained within a single JSON entity document.

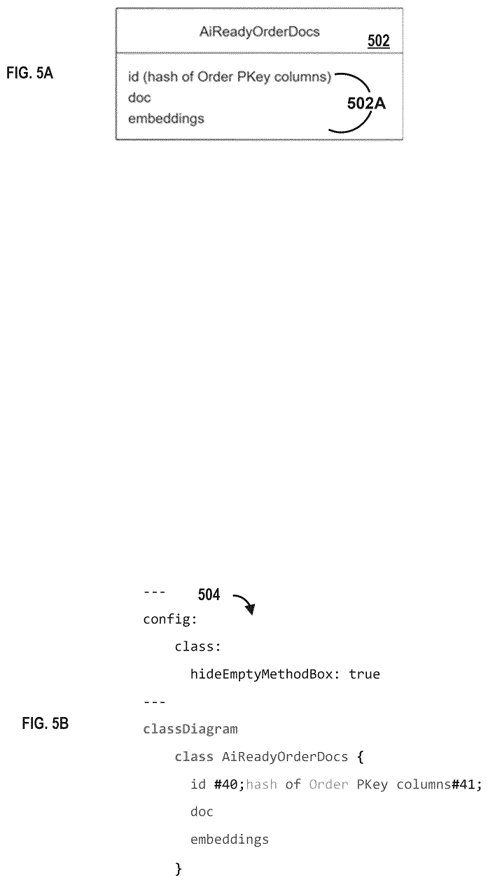

In RAG scenarios/implementations (e.g., the system 200 and/or 300), in order to use generated entity documents, such as the example JSON entity document 412, the system 300 may generate a semantic indexing table for semantic indexing, such as the semantic indexing table 502 in FIG. 5A (“AiReadyOrderDocs”). FIG. 5B, which provides a programmatic representation of the semantic indexing table 502, may illustrate how the table structure could be implemented as a class. The example code 504 in FIG. 5B might show a configuration setting where the “hideEmptyMethodBox” property could be set to true, followed by a class diagram definition. The class diagram may define the “AiReadyOrderDocs” class with the same three fields as shown in the table representation in FIG. 5A: id (hash of Order PKey columns), doc, and embeddings. This representation could demonstrate how the semantic indexing table structure might be represented programmatically, which could be useful for implementation purposes.

The columns 502A of the semantic indexing table 502 are: id—a hash of a concatenation of the root table's primary key columns; doc—a long text column containing the corresponding entity document; and embeddings—the embeddings vector of the entity document. The semantic indexing table 502 may be populated by the following process: (1) Selecting all documents from the OrdersJsonDocsView view; and (2) For each entity document, the system 300 uses an embedding model (e.g., vector database 206) to generate an embedding vector that matches the entity document (the ‘doc’ column), and the generated embedding vector is then stored it in the ‘embeddings’ column of the semantic indexing table 502. In some scenarios, the entity document may be split into multiple chunks to allow for more granular and selective matching when used.

The initial generation of each semantic indexing table 502 may be expensive from a computational standpoint, but it is done just once. The cost comes mostly from the need to compute the embeddings, as doing so requires the use of an AI embedding model (e.g., LLM 210) which often is a metered service. There is also the cost of regenerating the entity documents from the database, but that is a second order cost that we can ignore (even if it is still there). The main challenge in keeping a semantic indexing table 502 up to date is that the source data keeps changing by the application(s) that uses the semantic indexing table 502 (e.g., an app in an analytics system). Here, for example, the application that uses the semantic indexing table 502 may be an “Order Entry” application. When changes are detected, regenerating/updating the entire semantic indexing table to reflect those changes is very expensive from a computational standpoint. Examples of changes could include: a change in a product price affects all order documents including that product; a change in a customer address affects all order documents for that customer; a cancellation of an order requires the order document to be deleted; and/or a change in an order comment affect a specific order document.

Given a set of changes to application data, only the affected entity documents need to be re-indexed and updated in the corresponding semantic indexing table 502. The process includes the following steps: Step 1—Detect changes.; Step 2—Collect changes; and Step 3—Update index. These steps are repeated at a regular interval (e.g., based on a latency/freshness requirement of the corresponding app that uses the data) as well as on the cost of the process. When the cost of the process is high, it is typically repeated less often (for example when doing change detection by means of comparison with an old copy). The above 3 steps are described in the following sections.

Step 1—Detect changes: Change detection is not new. It needs to be implemented for each of the tables used for in the creation of the entity documents (assuming changes in those tables are of interest). There are multiple methods to implement change detection: Incrementally scanning each table using a change-time column (if one exists in the table). With this method, one can detect new data, changed data, and possibly deleted data (e.g., when using a logical delete marker); Using a comparison of the table to a saved copy of that table. This method is costly in terms of storage and processing, but it can detect new, changed, and deleted data without requiring any change to the tables.; and/or Using Change-Data-Capture (CDC) technology. For example, CDC technology may be used to parse a transaction log of a source database and deduce from it what rows have changed. In all those cases, it is assumed that we have a change table for each of the tables in which we are detecting changes.

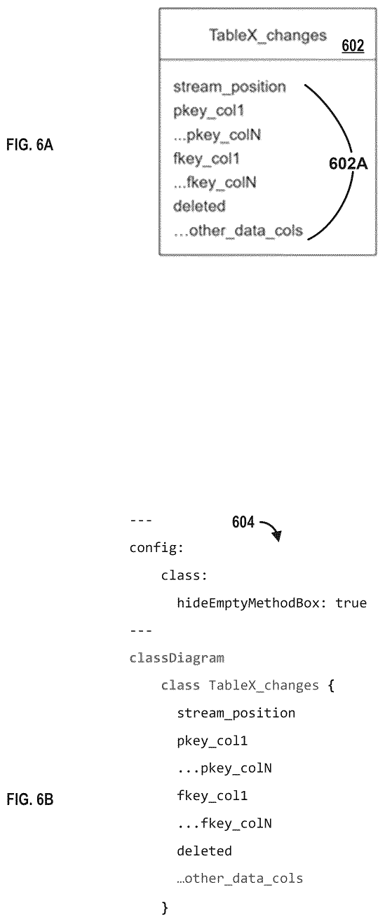

An example of a change table maintained for a table “X” in the data model 400 is shown in FIG. 6A. The data that needs to be stored in the change table is as follows (regardless of the method used to implement change detection). The change stream position that can be used to incrementally scan the change table (the “stream_position” in “TableX_changes”). The values of the columns constituting the primary key of the changed data row (e.g., “pkey_col1” and “pkey_colN”). If the change row also contains foreign key columns for parent tables in the model, they should be captured as well (e.g., “fkey_col1” and “fkey_colN”). A deletion indicator (e.g., “deleted” in the example above), which is set to true when the change was a delete. If false, it is assumed to be an insert or update (which are treated the same). Capturing more columns is optional and can be used to ignore changes made to data columns that are not of interest. The change detection can happen in near-real-time or periodically. When using log-based change detection, this step is typically lightweight in resource consumption and can occur continuously in near real-time. FIG. 6B, which depicts example code 604 for the change table system, may illustrate how the change table structure could be implemented programmatically. The code 604, which may include a configuration section specifying a class property “hideEmptyMethodBox” set to true, could be followed by a class diagram definition. The class diagram might define the TableX_changes class containing the same fields shown in FIG. 6A: stream_position, primary key columns, foreign key columns, deleted status, and other data columns. This programmatic representation could demonstrate how the change table 602 might be implemented in a system, which could be useful for developers implementing the change detection functionality.

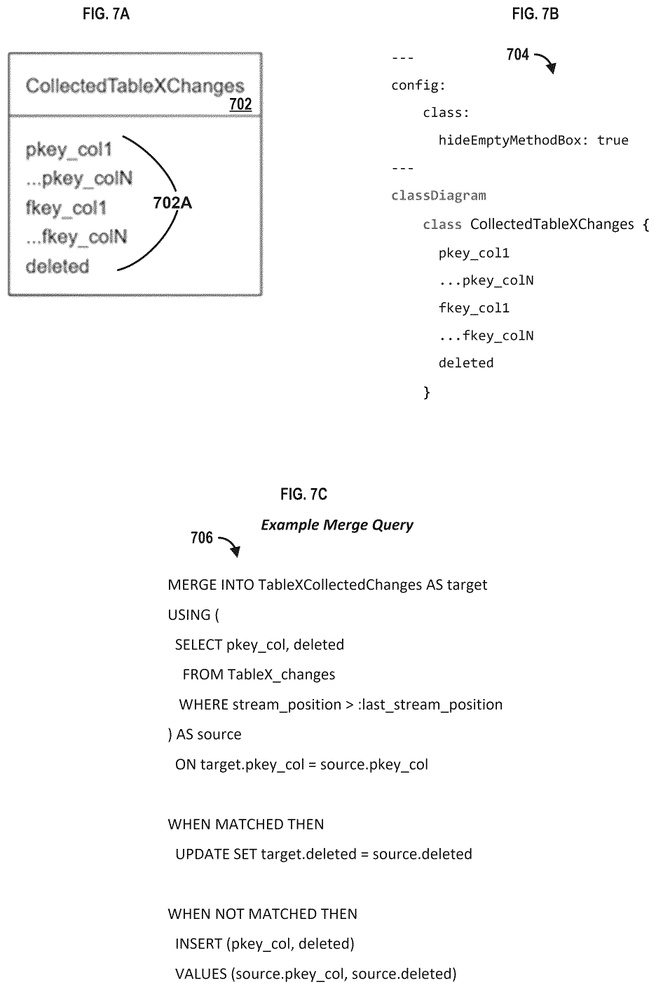

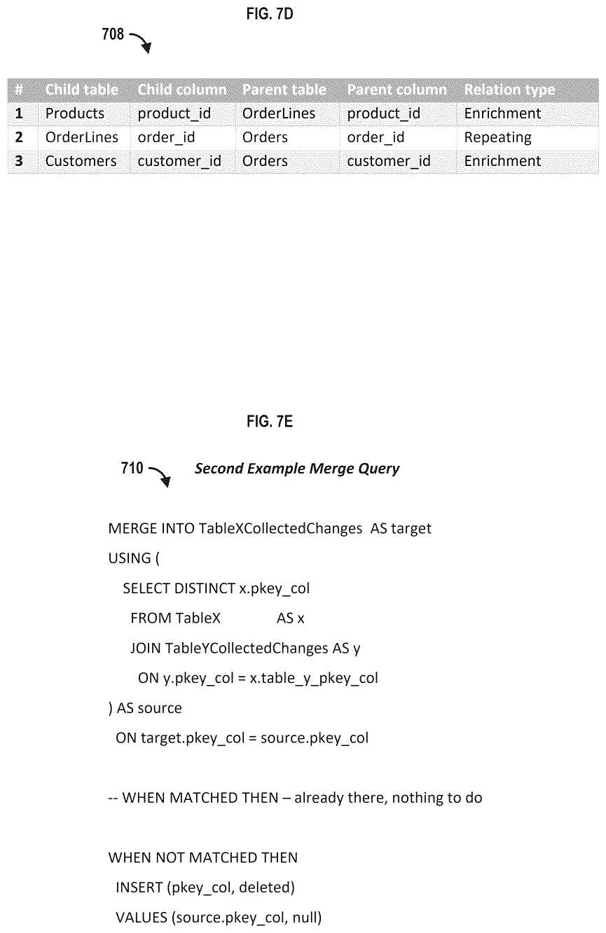

Step 2—Collect changes: The purpose of the Collect Changes step is to collect the list of instances of the root table (the primary key values) whose entity document needs updating. In collecting the changes, the system 300 uses helper tables. An example helper table for collecting changes is the “CollectedTableXChanges” table is shown in FIG. 7A. Note that when discussing the collected changes table of the root table of the data model 400 (e.g., of the “Orders” table in FIG. 4A), the helper table for collecting those changes is referred to herein as the “CollectedRootChanges” table. The CollectedRootChanges table stores the primary key values for the rows of the root table whose entity document needs to be updated (e.g., with a new entity document and embeddings) or deleted in the semantic indexing table 502. FIG. 7B, which depicts example code 704 for the collected changes table, may illustrate how the table structure could be implemented programmatically. The code 704, which might include a configuration class with a property “hideEmptyMethodBox” set to true, could be followed by a class diagram definition for CollectedTableXChanges. The class diagram may specify the structure matching the collected changes table 702 shown in FIG. 7A, which could include the primary key columns, foreign key columns, and deleted indicator. This programmatic representation might demonstrate how the collected changes table 702 could be implemented in a system, which may be useful for developers implementing the change collection functionality.

The collect change step has the following 3 sub-steps. First, truncate the CollectedTableXChanges table 702 for all tables in the data model 400. Second, collect the changes for each of the tables in the data model 400 from the change table, TableX_changes 602, into the corresponding CollectedTableXChanges table 702. In this sub step, only changes added since the last batch are updated based on the last stream position (“stream_position”) for each of the changed tables handled in the previous batch. Third, traverse the data model 400 from its leaves to the root entity (e.g., from the “Products” table to the “OrderLines” table to the “Orders” table in the data model 400 of FIG. 4), and, in each step of that traversal, update the parent table's CollectedParentChanges table based on a CollectedChildChanges table corresponding to the particular leaf being traversed. For example, the CollectedParentChanges table for the “OrderLines” table in the example above would be updated based on the CollectedChildChanges table for the “Products” table, which is the parent table for the “OrderLines” table. For sub-step 2 of the collect change step above, collecting the changes for each of the tables in the data model from the change table, TableX_changes 602, into the corresponding CollectedTableXChanges table 702 may use a merge query like the Example Merge Query shown in FIG. 7C. For simplicity, the Example Merge Query shown in FIG. 7C assumes just one column in the primary key, but if there are multiple columns, they should be added as appropriate.

In sub-step 3, the data model 400 is traversed from its leaves to the root entity, and the parent table's CollectedParentChanges table is updated based on the CollectedChildChanges table corresponding to the particular leaf being traversed. An example of the corresponding traversal steps of the data model 400 is shown in the table 708 of FIG. 7D. The “Enrichment” entry in the “Relationship type” column in the table 708 refers to a 1-1 (one-to-one) relationship (foreign key to primary key), while the “Repeating” entry in the “Relationship type” column in the table 708 refers to a 1-Many (one-to-many) relationship. In an example “Enrichment” relationship where TableX is the parent of Table Y in the data model, TableX would have “table_y_pkey_col” (note that in the example in FIG. 4, “OrderLines” is the parent of “Products” and has product_id as the foreign key for “Products”). The query to aggregate/collect the parent table's (TableX) changes in the TableXCollectedChanges table, based on changes in the child table (TableY), needs to use the Table Y primary keys from the Table YCollectedChanges table and look-up the current values for the TableY primary keys in TableX (See Second Example Merge Query in FIG. 7E. It should be noted that, in some scenarios, the rows added to the TableXCollectedChanges table may not have all change information—just the affected primary key. This might result in more changes being detected in some advanced scenarios (e.g. when it would not be possible to ignore specific kinds of changes based on data type, etc.). In such a scenario, however, the query would not yield incorrect results, only slight inefficiency. FIG. 7E, which shows the second example merge query 710, may illustrate the SQL syntax that could be used for merging data into a TableXCollectedChanges table. The query 710, which might include a MERGE statement with a USING clause, could perform a JOIN operation between TableX and Table YCollectedChanges. The query may specify conditions for matching records and might include logic for handling both matched and unmatched cases, with instructions for inserting new records when no match is found. The query could begin with “MERGE INTO TableXCollectedChanges AS target” followed by a USING clause that might select distinct primary key columns from TableX joined with Table YCollectedChanges. The ON clause may establish the matching condition between target and source tables. The query might include a commented section for WHEN MATCHED THEN, indicating that when records match, no action may be required since the data could already be present. For unmatched records, the query could include a WHEN NOT MATCHED THEN clause that might perform an INSERT operation, capturing the primary key column and setting the deleted field to null. This SQL implementation could demonstrate how the traversal of the data model might be implemented in practice, which may be valuable for developers implementing the change collection functionality.

Step 3—Update index: The index 502 is updated after the Collect Changes step has completed, and it involves a recursive step with one or more sub-steps. For example, the CollectedRootChanges table may be scanned, and for each row the following three steps may be performed. First, the system 300 calculates the “id” as the hash of the concatenated root table primary key columns. Next, the row of the semantic indexing table 502 where the “id” column equals the calculated “id” are deleted. If the deletion indication is false or null, the system 300 may then insert into the semantic indexing table 502 a row for the “id,” the entity document (doc), and the entity document's embeddings vector (embeddings). The entity document is re-created from the entity document view in the database (e.g., OrdersJsonDocs View) based on the root table primary key.

The process 350 may begin with step 352, which involves detecting changes in the data model. This step may utilize various methods to identify modifications, additions, or deletions in the source data. The system may employ incremental scanning of tables using change-time columns, comparison with saved copies of tables, or Change-Data-Capture (CDC) technology to parse transaction logs. The detection process may generate change tables for each relevant table in the data model.

Step 354 may involve collecting the detected changes. The system may use helper tables, such as the CollectedTableXChanges table shown in FIG. 7A, to aggregate the changes. This step may prepare the data for further processing and updating of the semantic indexing table. At step 356, the process may determine if there are changes to collect. This decision point may guide the subsequent flow of the process. If changes are detected, the process may proceed to step 358. If no changes are found, the process may skip to step 364. Step 358 may involve truncating the CollectedTableXChanges tables for all tables in the data model. This action may clear out any previous change data, ensuring that only the most recent changes are processed. The truncation may prepare the tables for the new batch of changes to be collected.

In step 360, the process may collect changes from the TableX_changes into the corresponding CollectedTableXChanges table. This step may utilize a merge query similar to the one shown in FIG. 7C. The query may select changes based on the stream position, updating only the changes added since the last batch. Step 362 may involve traversing the data model from its leaf tables to the root entity. During this traversal, the system may update the CollectedParentChanges table based on the CollectedChildChanges table for each step. This process may ensure that changes in child tables are properly reflected in their parent tables. If no changes were detected at step 356, the process may proceed to step 364 to update the index. This step may involve modifying the semantic indexing table based on the collected changes. The update process may ensure that the index reflects the current state of the data. Step 366 may involve scanning the CollectedRootChanges table. This table may contain the primary key values for rows in the root table that require updating or deletion in the semantic indexing table. The system may process each row in this table to determine the necessary actions. At step 368, the process may check if the deletion indicator is false or null for each row in the CollectedRootChanges table. This decision point may determine whether a row should be inserted or deleted from the semantic indexing table.

If the deletion indicator is false or null, the process may proceed to step 370. In this step, the system may insert a new row into the semantic indexing table. The insertion may include calculating an “id” as a hash of the concatenated root table primary key columns, creating a new entity document, and generating new embeddings for the document. If the deletion indicator is true, the process may move to step 372.

If the deletion indicator is true, the process may move to step 372. In this step, the system would delete the corresponding row from the semantic indexing table. This deletion is performed based on the calculated “id” value, which is a hash of the concatenated root table primary key columns. By removing the row, the system ensures that outdated or no longer relevant information is removed from the semantic indexing table, maintaining the accuracy and relevance of the knowledge base. This step is crucial for maintaining data integrity, especially when dealing with deleted records in the source data. After completing either the insertion (step 370) or deletion (step 372) operation, the process may continue to the next row in the CollectedRootChanges table, if any, or conclude the update process if all rows have been processed. This iterative approach ensures that all necessary changes are applied to the semantic indexing table, keeping it synchronized with the latest state of the source data.

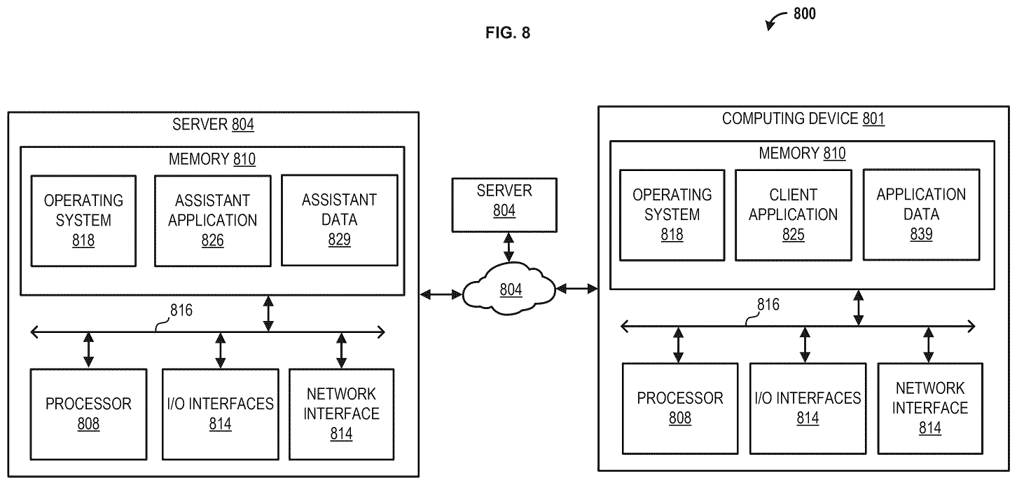

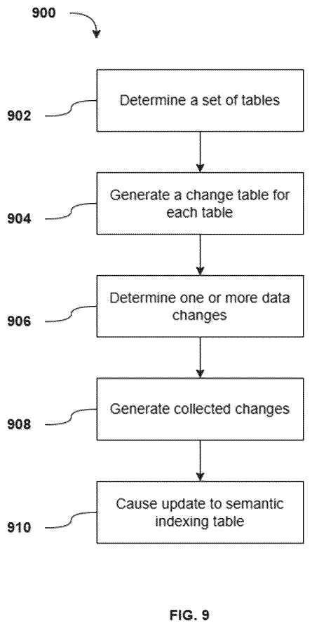

The present methods and systems may be computer-implemented. FIG. 8 shows a block diagram depicting a system/environment 800 comprising non-limiting examples of a computing device 801 and a server 802 connected through a network 804. Either of the computing device 801 or the server 802 may be a computing device, such as any of the devices of the system 100 shown in FIG. 1, the system 200 shown in FIG. 2, or the system 300 shown in FIG. 3A. In an aspect, some or all steps of any described method may be performed on a computing device as described herein. The computing device 801 may comprise one or multiple computers configured to store application data 839, and/or the like. The server 802 may comprise one or multiple computers configured to store assistant data 829. Multiple servers 802 may communicate with the computing device 801 via the through the network 804.

The computing device 801 and the server 802 may be a digital computer that, in terms of hardware architecture, generally includes a processor 808, system memory 810, input/output (I/O) interfaces 812, and network interfaces 814. These components (808, 810, 812, and 814) are communicatively coupled via a local interface 816. The local interface 816 may be, for example, but not limited to, one or more buses or other wired or wireless connections, as is known in the art. The local interface 816 may have additional elements, which are omitted for simplicity, such as controllers, buffers (caches), drivers, repeaters, and receivers, to enable communications. Further, the local interface may include address, control, and/or connections to enable appropriate communications among the aforementioned components.

The processor 808 may be a hardware device for executing software, particularly that stored in system memory 810. The processor 808 may be any custom made or commercially available processor, a central processing unit (CPU), an auxiliary processor among several processors associated with the computing device 801 and the server 802, a semiconductor-based microprocessor (in the form of a microchip or chip set), or generally any device for executing software instructions. When the computing device 801 and/or the server 802 is in operation, the processor 808 may execute software stored within the system memory 810, to communicate data to and from the system memory 810, and to generally control operations of the computing device 801 and the server 802 pursuant to the software.

The I/O interfaces 812 may be used to receive user input from, and/or for providing system output to, one or more devices or components. User input may be provided via, for example, a keyboard and/or a mouse. System output may be provided via a display device and a printer (not shown). I/O interfaces 812 may include, for example, a serial port, a parallel port, a Small Computer System Interface (SCSI), an infrared (IR) interface, a radio frequency (RF) interface, and/or a universal serial bus (USB) interface.

The network interface 814 may be used to transmit and receive from the computing device 801 and/or the server 802 on the network 804. The network interface 814 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 814 may include address, control, and/or data connections to enable appropriate communications on the network 804.

The system memory 810 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 810 may incorporate electronic, magnetic, optical, and/or other types of storage media. Note that the system memory 810 may have a distributed architecture, where various components are situated remote from one another, but may be accessed by the processor 808.

The software in system memory 810 may include one or more software programs, each of which comprises an ordered listing of executable instructions for implementing logical functions. In the example of FIG. 8, the software in the system memory 810 of the computing device 801 may comprise the application data 839, the client application 825, and a suitable operating system (O/S) 818. In the example of FIG. 8, the software in the system memory 810 of the server 802 may comprise the assistant data 829, the assistant application 826, and a suitable operating system (O/S) 818. The operating system 818 essentially controls the execution of other computer programs and provides scheduling, input-output control, file and data management, memory management, and communication control and related services.

For purposes of illustration, application programs and other executable program components such as the operating system 818 are shown herein as discrete blocks, although it is recognized that such programs and components may reside at various times in different storage components of the computing device 801 and/or the server 802. An implementation of the system/environment 800 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

FIG. 9 shows a flowchart of an example method 900. The method 900 may be performed in whole or in part by a single computing device, a plurality of computing devices, and the like. For example, the steps of the method 900 may be performed by the computing device 102. Some steps of the method 900 may be performed by a first computing device, while other steps of the method 900 may be performed by another computing device.

The method 900 may begin at step 902, where the system may determine a set of tables used for creation of entity documents. For example, the system may determine the set of tables based on a data model. The data model may include relationships between multiple tables. The system may identify which tables contain data relevant to generating entity documents. These entity documents may serve as the basis for semantic indexing in a RAG system.

At step 904, the system may generate a change table for each table in the set of tables. For example, the system may generate each change table based on the set of tables. Each change table may store information about modifications made to its corresponding table. The change table may include fields for stream position, primary key columns, foreign key columns, and a deletion indicator. The system may implement various methods for detecting changes to populate these change tables. The system may use incremental scanning with a change-time column. The system may alternatively use change-data-capture technology to parse a transaction log of a source database.

At step 906, the system may determine, based on the change tables, one or more changes to data in the set of tables. The system may identify which records have been added, modified, or deleted since the last update. The system may track these changes using the stream position field to enable incremental processing. At step 908, the system may generate, based on the one or more changes, a collected changes table for each table in the set of tables. The generation of collected changes tables may involve truncating existing collected changes tables for each table in the set of tables. The system may then collect changes for each table from the corresponding change table into the corresponding collected changes table. The system may traverse the data model from leaf tables to a root entity table. The system may update a parent table's collected changes table based on a child table's collected changes table during this traversal.

At step 910, the system may cause, based on the collected changes tables, an update to a semantic indexing table. The update to the semantic indexing table may involve calculating an identifier as a hash of concatenated root table primary key columns. The system may delete a row of the semantic indexing table where an identifier column equals the calculated identifier. The system may insert, based on a deletion indicator being false or null, a new row into the semantic indexing table. The new row may include the calculated identifier, an updated entity document, and newly generated embeddings for that document. This approach may allow the system to efficiently update only the affected portions of the semantic indexing table rather than regenerating the entire table.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification. It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
determining, based on a data model, a set of tables used for creation of entity documents;
generating, based on the set of tables, a change table for each table in the set of tables;
determining, based on the change tables, one or more changes to data in the set of tables;
generating, based on the one or more changes, a collected changes table for each table in the set of tables; and
causing, based on the collected changes tables, an update to a semantic indexing table.

2. The method of claim 1, wherein determining the one or more changes to data in the set of tables comprises incrementally scanning each table using a change-time column.

3. The method of claim 1, wherein determining the one or more changes to data in the set of tables comprises parsing a transaction log of a source database.

4. The method of claim 1, wherein generating the collected changes table for each table in the set of tables comprises truncating an existing collected changes table for each table in the set of tables.

5. The method of claim 4, further comprising collecting changes for each table in the set of tables from the corresponding change table into the corresponding collected changes table.

6. The method of claim 5, further comprising:
traversing the data model from leaf tables to a root entity table; and
updating a parent table's collected changes table based on a child table's collected changes table.

7. The method of claim 1, wherein causing the update to the semantic indexing table comprises:
calculating an identifier as a hash of concatenated root table primary key columns;
deleting a row of the semantic indexing table where an identifier column equals the calculated identifier; and
inserting, based on a deletion indicator being false or null, a new row into the semantic indexing table.

8. A system comprising:
a vector database; and
a first computing device configured to:
determine, based on a data model, a set of tables used for creation of entity documents;
generate, based on the set of tables, a change table for each table in the set of tables;
determine, based on the change tables, one or more changes to data in the set of tables;
generate, based on the one or more changes, a collected changes table for each table in the set of tables; and
cause, based on the collected changes tables, an update to a semantic indexing table in the vector database.

9. The system of claim 8, wherein determining the one or more changes to data in the set of tables comprises incrementally scanning each table using a change-time column.

10. The system of claim 8, wherein determining the one or more changes to data in the set of tables comprises parsing a transaction log of a source database.

11. The system of claim 8, wherein generating the collected changes table for each table in the set of tables comprises truncating an existing collected changes table for each table in the set of tables.

12. The system of claim 11, wherein the first computing device is further configured to collect changes for each table in the set of tables from the corresponding change table into the corresponding collected changes table.

13. The system of claim 12, wherein the first computing device is further configured to:
traverse the data model from leaf tables to a root entity table; and
update a parent table's collected changes table based on a child table's collected changes table.

14. The system of claim 8, wherein causing the update to the semantic indexing table comprises:
calculating an identifier as a hash of concatenated root table primary key columns;
deleting a row of the semantic indexing table where an identifier column equals the calculated identifier; and
inserting, based on a deletion indicator being false or null, a new row into the semantic indexing table.

15. A non-transitory computer-readable medium storing instructions that, when executed by one or more processors, cause the one or more processors to:
determine, based on a data model, a set of tables used for creation of entity documents;
generate, based on the set of tables, a change table for each table in the set of tables;
determine, based on the change tables, one or more changes to data in the set of tables;
generate, based on the one or more changes, a collected changes table for each table in the set of tables; and
cause, based on the collected changes tables, an update to a semantic indexing table.

16. The non-transitory computer-readable medium of claim 15, wherein determining the one or more changes to data in the set of tables comprises incrementally scanning each table using a change-time column.

17. The non-transitory computer-readable medium of claim 15, wherein determining the one or more changes to data in the set of tables comprises parsing a transaction log of a source database.

18. The non-transitory computer-readable medium of claim 15, wherein generating the collected changes table for each table in the set of tables comprises truncating an existing collected changes table for each table in the set of tables.

19. The non-transitory computer-readable medium of claim 18, the operations further comprising:
collecting changes for each table in the set of tables from the corresponding change table into the corresponding collected changes table;
traversing the data model from leaf tables to a root entity table; and
updating a parent table's collected changes table based on a child table's collected changes table.

20. The non-transitory computer-readable medium of claim 15, wherein causing the update to the semantic indexing table comprises:
calculating an identifier as a hash of concatenated root table primary key columns;
deleting a row of the semantic indexing table where an identifier column equals the calculated identifier; and
inserting, based on a deletion indicator being false or null, a new row into the semantic indexing table.
